(19) United States
(12) Patent Application Publication
(10) Pub. No.: US 2005/0110898 A1
(43) Pub. Date: May 26, 2005

(54) Power supply for image-forming apparatuses having a power management function

(75) Inventor: Han-chung Ryu, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/995,439

(22) Filed: Nov. 24, 2004

(30) Foreign Application Priority Data
Nov. 25, 2003 (KR) 2003-83921

(51) Int. Cl. H04N 5/225

(52) U.S. Cl. 348/372

(57) ABSTRACT

A power supply for image-forming apparatuses having a power management function. The power supply comprises a power supply unit for rectifying and converting AC power into DC power, and then applying the DC power to at least one or more function modules comprising the image-forming apparatus. A switching unit is provided between an output terminal of the power supply unit and an input terminal of each of the function modules, and a control unit is provided for turning on and off the switching unit when the image-forming apparatus enters a power management mode. A power-saving switch is also provided for applying a signal to the control unit for selectively setting the power management mode. Such a power supply enables users to effectively manage power consumption by preventing voltage application to the function modules when no longer required or safe to do so.

### CROSS-REFERENCE TO RELATED APPLICATIONS

This application claims the benefit under 35 U.S.C. §119(a) of Korean Patent Application No. 2003-83921, filed in the Korean Intellectual Property Office on Nov. 25, 2003, the entire contents of which are incorporated herein by reference.

### BACKGROUND OF THE INVENTION

1. Field of the Invention

The present invention relates to a power supply for image-forming apparatuses. More particularly, the present invention relates to a power supply for image-forming apparatuses and having a power management function and capability to reduce power consumption of the image-forming apparatuses and enhance user safety.

2. Description of the Related Art

In general, image-forming apparatuses such as laser printers, digital photocopiers, and facsimile machines are driven under environments of high temperature and high voltage. In the case of laser printers, the organic photoconductor (OPC) is charged with over several hundred volts, and sheets of paper pass through the fixing roller heated to a high temperature such as 200° C. in order for toner to be fixed on the passing sheets. In the image-forming apparatus driven under such high-temperature and high-voltage environments, users will have to open the cover of the image-forming apparatus from time to time due to toner replacement requirements, paper jams, and so on, and when the cover is opened, the power applied to the image-forming apparatus is cut off to secure user safety.

FIG. 1 is a schematic of a power supply built in a conventional image-forming apparatus.

The power supply shown in FIG. 1 has a switch 1, an EMC filter 2, a first rectifier 3, a switching controller 4, a transformer 5, a second rectifier 6, and an interlock switch 7.

The switch 1, connected between the electric power (AC) and the EMC filter 2, extends out of the image-forming apparatus and is used by user to turn the image-forming apparatus off and on. Therefore, the switch 1 is not often used by the user and is typically provided at the rear or side of the image-forming apparatus such that the user undergoes some inconvenience when manipulating it. Further, in the schematic of FIG. 1, the electric power (AC) is applied to the EMC filter 2, which therefore requires a switch having a high withstand voltage and current rating. Such a switch is bulky and expensive, which becomes a factor and increases the manufacturing costs of the image-forming apparatus.

The EMC filter 2 reduces noise present in the power source (AC). In general, the EMC filter 2 consists of coils and capacitors such as an LC filter, connected in series and parallel with the electric power (AC).

The first rectifier 3 rectifies the electric power (AC) passing through the EMC filter 2 into direct current (DC) power. FIG. 1 shows a bridge diode and a capacitor rectifying an output of the EMC filter 2. The switching controller 4 performs switching operations with respect to the DC power passing through the transformer 5 to turn on and off the current path formed in the primary winding of the transformer 5.

The transformer 5 is turned on and off by the switching controller 4 such that AC power is induced in a secondary winding. The second rectifier 6 rectifies the AC power induced in the transformer 5 to generate desired DC power, for example, 24V. The interlock switch 7 is connected between the output terminal of the second rectifier 6 and plural function modules 8 provided in the image-forming apparatus. Further, the interlock switch 7 operates in relation with the cover, which protects a user from danger when a user opens the cover to remove paper jams or to replace the toner. As the image-forming apparatus operates under high temperature and voltage during the driving of the image-forming apparatus, if the interlock switch 7 is turned off when the cover is opened, the power to the respective function modules 8 of the image-forming apparatus is turned off. Further, the image-forming apparatus, for example, a laser printer, generally consumes power over a range of between 70 to 100 W when in the print standby state, and consumes power up to 10 to 20 W even when in the idle state, which results because the fixing unit has to be pre-heated in order for the toner to be fixed on paper even when in the print standby state. Therefore, even though the power to the fixing unit is cut off when in the idle state, the respective function modules 8 connected to the power supply consume power of up to 10 to 20 W. Therefore, the image-forming apparatus such as a laser printer, digital photocopier, and facsimile machine has a problem of wasting unnecessary power while not driven in use.

Accordingly, a need exists for a system and method to effectively manage power consumption by preventing voltage application to apparatus function modules when no longer required or safe to do so.

### SUMMARY OF THE INVENTION

The present invention has been developed in order to solve the above and other problems associated with the conventional devices. An aspect of the present invention is to provide a power supply for an image-forming apparatus facilitating the management of the power consumption in the image-forming apparatus, together with reducing the cost of required parts, such as switches.

The foregoing and other objects and advantages are substantially realized by providing a power supply for an image-forming apparatus having a power management function comprising a power supply unit for rectifying and converting AC power into DC power, and for further applying the DC power as operation power to at least one or more function modules constituting the image-forming apparatus. A switching unit can be provided between an output terminal of the power supply unit and an input terminal of each of the function modules, and a control unit can be provided for turning on and off the switching unit when the image-forming apparatus enters a power management mode. A power-saving switch can also be provided between an output terminal of the power supply unit and the control unit for applying a voltage to the control unit, wherein the voltage is applied to the control unit as a signal for setting the power management mode.

The switch unit may be provided on an operation panel at one side of the main body of the image-forming apparatus, thereby enabling users to easily manipulate the image-forming apparatus.

The image-forming apparatus may include a cover for replacing the function modules, and a sensor for detecting whether the cover is open, such that the switching unit is turned off if the cover is detected to be open.

The switching unit may also include a relay having a relay contact connected between the output terminal of the power supply unit and the function modules, and having one end of a contact activating driving coil connected to the output terminal of the power supply unit. A transistor may also be included, having an emitter electrode connected to the other end of the driving coil, a collector electrode connected to ground, and a base electrode used to receive a signal for setting the power management mode.

The foregoing and other objects and advantages are also substantially realized by providing a power supply for an image-forming apparatus comprising a print engine unit for performing print tasks with respect to data to be printed, an image-processing unit for converting the print data into data in an image data format, an engine control unit for controlling the print engine unit to perform the print tasks with respect to the image data, and a power supply unit for driving the print engine unit, image-processing unit, and engine control unit. The power supply unit can include a relay for turning on and off an output voltage thereof, wherein the relay is turned off by the engine control unit when the image-forming apparatus, provided with the print engine unit, image-processing unit, and engine control unit, enters a power management mode for reducing power consumption.

The image-forming apparatus may be provided with an operation panel that is disposed at one side of the image-forming apparatus and enables a user to easily manipulate the image-forming apparatus, and further comprises a switch for turning off the relay.

The image-forming apparatus may also be provided with an operation panel that is disposed at one side of the image-forming apparatus and enables a user to easily manipulate the image-forming apparatus, and further comprises a switch for turning on and off the output voltage of the power supply unit.

The power management mode described above is a mode for cutting off and reducing power applied to the print engine unit if print data is not supplied to the image-processing unit for a certain period of time.

The power management mode may also be carried out by the driving of the relay upon the opening of a cover shielding the interior from the exterior of the image-forming apparatus.

### BRIEF DESCRIPTION OF THE DRAWINGS

The above aspects and features of the present invention will become more apparent by describing certain embodiments of the present invention with reference to the accompanying drawings, in which:

FIG. 1 is a schematic of a power supply built in a conventional image-forming apparatus;

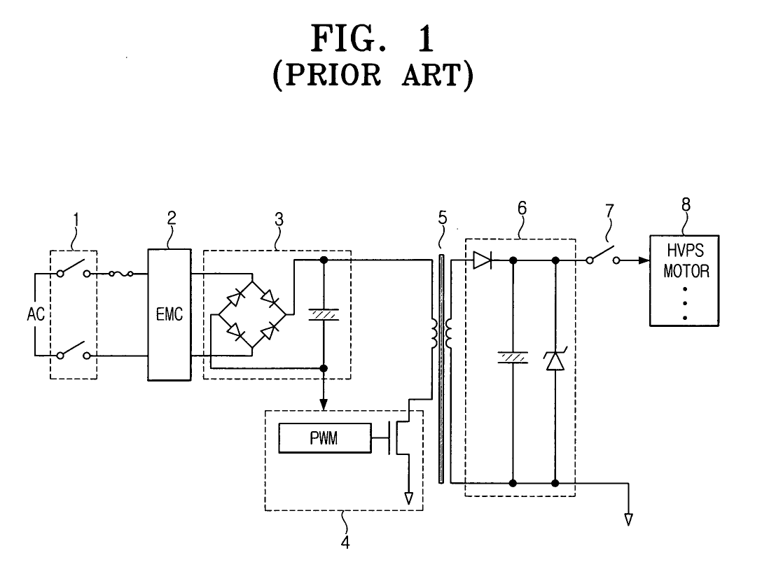

FIG. 2 is a block diagram illustrating an image-forming apparatus having a power supply according to an embodiment of the present invention;

FIG. 3 is a block diagram illustrating an image-forming apparatus having a power supply according to another embodiment of the present invention;

FIG. 4 is a schematic of a power supply according to yet another embodiment of the present invention; and

FIG. 5 is a perspective view for illustrating a position of the switch of FIG. 4 when installed on the image-forming apparatus in accordance with an embodiment of the present invention.

Throughout the drawings, like reference numerals will be understood to refer to like parts, components and structures.

### DETAILED DESCRIPTION OF THE EXEMPLARY EMBODIMENTS

Hereinafter, the present invention will be described in greater detail with reference to the accompanying drawings.

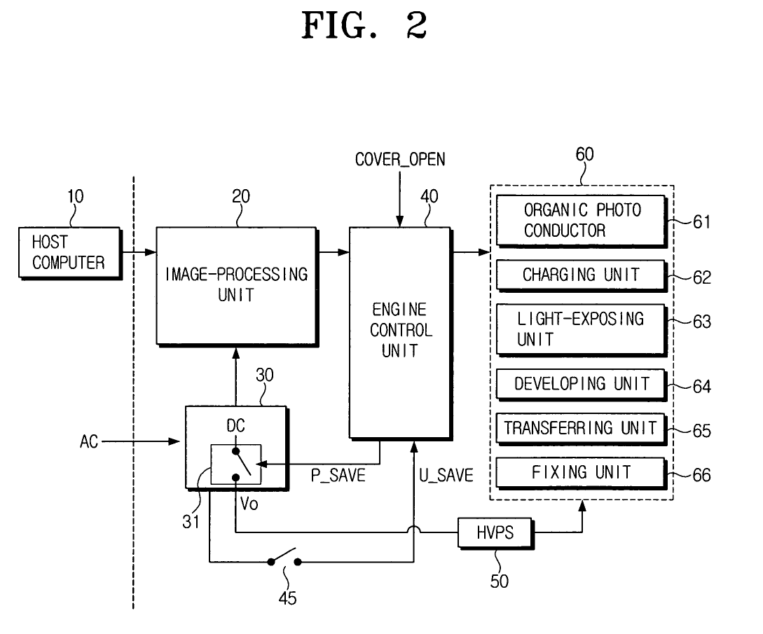

FIG. 2 is a block diagram illustrating an image-forming apparatus having a power supply according to an embodiment of the present invention.

The image-forming apparatus shown in FIG. 2 includes an image-processing unit 20, a switched mode power supply (SMPS) 30, an engine control unit 40, a switch 45, a high voltage power supply (HVPS) 50, and a print engine part 60.

The image-processing unit 20 converts print data applied from a host computer 10 into data in an image data format, for example, data in the bitmap format, which can be processed in the engine control unit 40. The switched mode power supply 30 generates electric power for driving the image-processing unit 20, engine control unit 40, high voltage power supply 50, and print engine part 60. The switched mode power supply 30 rectifies AC power into a DC power output having a certain desired voltage value, for example, 24V, and connects the relay 31 to the output terminal Vo so that the relay 31 can turn on and off the output voltage. The relay 31 is controlled to be turned on and off by a control signal P_SAVE output from the engine control unit 40. In this case, the output voltage of the switched mode power supply 30 is very low compared to the output voltage of the high voltage power supply 50 or the AC power, so the relay 31 provided in the switched mode power supply 30 can have a lower withstand voltage and current rating. Accordingly, a low-priced switch can be used to switch the AC power on and off when compared to the conventional switches used.

The engine control unit 40 controls the driving of the print engine part 60 based on the image data applied from the image-processing unit 20. The engine control unit 40 is coupled with various sensors, for example, the cover sensor (not shown), provided in the image-forming apparatus to detect whether the cover is open, or reads information from a thermal sensor (not shown) detecting the temperature of the fixing unit 66, to thereby control the print engine part 60. When a user opens the cover for toner replacement, the engine control unit 40 applies a control signal P_SAVE to the switched mode power supply 30 thereby turning off the relay 31 in response to a signal COVER_OPEN generated by the cover sensor (not shown), so as to cut off a voltage applied to the high voltage power supply 50 from the switched mode power supply 30. Therefore, when the user opens the cover, the safety of the user can be ensured.

If data having a bitmap format is not applied through the image-processing unit 20 for over a period of time, for example, 30 minutes, the engine control unit 40 recognizes a standby state, and, if data having a bitmap format is not applied while in the standby state for over another period of time, for example, 15 minutes, the engine control unit 40 recognizes an idle state, and outputs the control signal P_SAVE to the relay 31. If the relay 31 is turned off by the control signal P_SAVE, the power to the high voltage power supply 50 is cut off such that the image-forming apparatus consumes power of less than a few Watts, for example, 1 W.

The switch 45 is provided between the switched mode power supply 30 and the engine control unit 40. The switch 45 applies the output voltage of the switched mode power supply 30 to the engine control unit 40 as a signal U_SAVE for setting a power management mode. If the switch 45 is turned on, the engine control unit 40 turns off the relay 31 so that the image-forming apparatus minimizes its power consumption. That is, the switch 45 enables a user to arbitrarily and selectively reduce the power consumption of the image-forming apparatus, so it is preferable to place the switch 45 on the operating panel (not shown) for the user to easily manipulate.

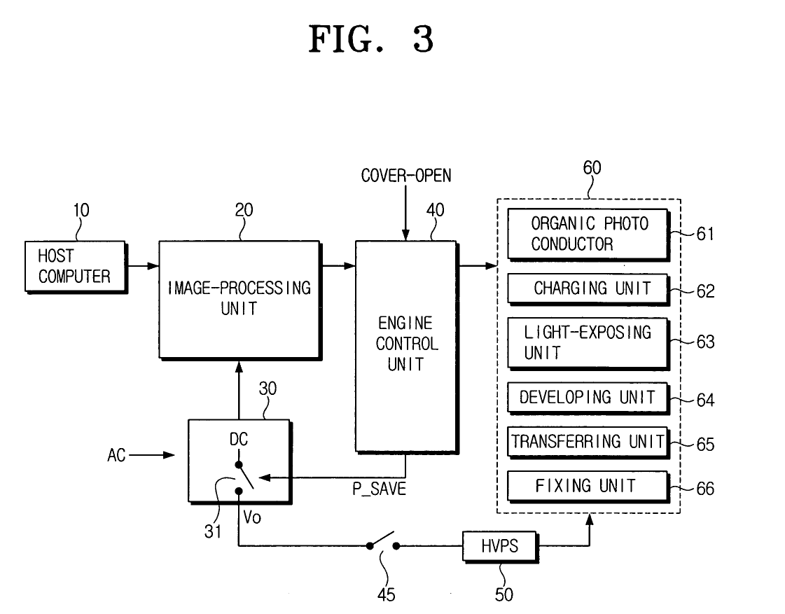

The print engine part 60 is driven by the engine control unit 40 so as to print certain images on a printing medium such as paper, and includes mechanical units such as motors, rollers, and organic photo conductors. In the example shown in FIGS. 2 and 3, the print engine part 60 can include an organic photo conductor 61, a charging unit 62, a light-exposing unit 63, a developing unit 64, a transferring unit 65, and a fixing unit 66.

FIG. 3 is a block diagram for illustrating an image-forming apparatus according to another embodiment of the present invention.

The image-forming apparatus shown in FIG. 3 is substantially similar to that shown in FIG. 2, but differs from FIG. 2 in that the switch 45 shown in FIG. 2 is now placed between the output terminal Vo of the relay 31 and the high voltage power supply 50, so that the power from the switched mode power supply 30 to the high voltage power supply 50 can be completely cut off. The operations of the remaining components shown in FIG. 3 are substantially the same as those described in FIG. 2, so a description on the operations of each will be omitted.

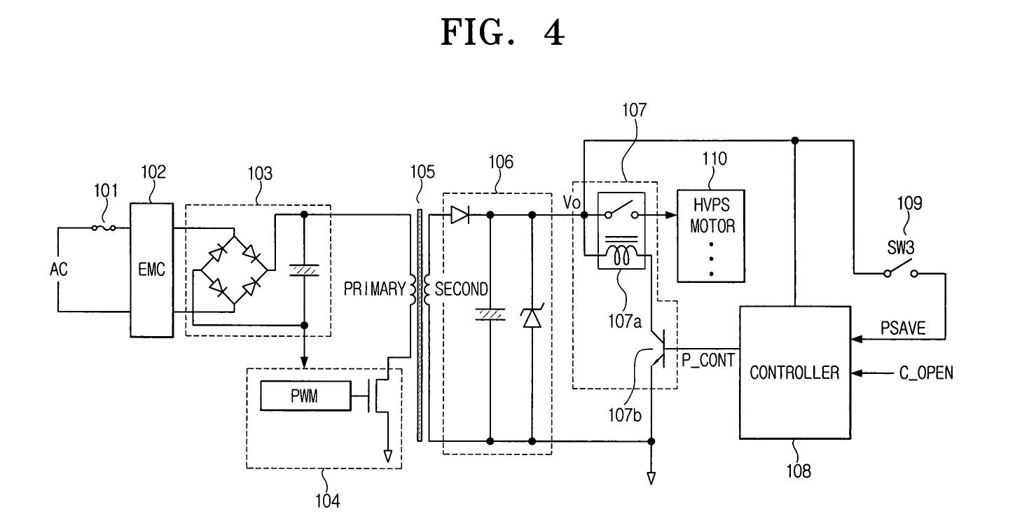

FIG. 4 is a schematic of a power supply according to yet another embodiment of the present invention.

The power supply shown in FIG. 4 includes a fuse 101, an EMC filter 102, a first rectifier 103, a switching controller 104, a transformer 105, a second rectifier 106, a switching unit 107, a controller 108, and an interlock switch 109.

The fuse 101 is connected between AC power and the EMC filter 102, and cuts off the AC power applied to the EMC filter 102 when the AC power applied to the EMC filter 102 exceeds the rating of the EMC filter, so as to protect the power supply.

The EMC filter 102 reduces noise present in the AC power source. In general, the EMC filter 102 includes coils and capacitors such as an LC filter, connected in series and parallel with respect to the AC power.

The first rectifier 103 rectifies and converts the AC power passing through the EMC filter 102 into DC power. FIG. 3 shows a bridge diode-type rectifier having a conversion efficiency of about 80%, and wherein the voltage rectified through the bridge diode-type rectifier then becomes smooth by the filter effect of a capacitor coupled between outputs of the bridge diode-type rectifier.

The switching controller pulse with modulator (PWM) 104 switches the DC power through the transformer 105 on and off with PWM pulses having a predetermined pulse width, turning on and off the current formed in the primary winding of the transformer 105. Thus, the transformer 105 is turned on and off by the switching controller 104, inducing AC power in the secondary winding of the transformer 105. In this example, the turns ratio n of the primary to secondary windings of the transformer 105 is 1, that is 1:1, and the transformer 105 outputs a low AC voltage compared to the switched DC voltage input across the primary winding.

The second rectifier 106 rectifies and converts the AC power output from the secondary winding of the transformer 105 into a DC power output having a certain desired voltage value, for example, 24V, and applies the DC power to the switching unit 107.

The switching unit 107 is provided between the input terminals of the function modules 110, such as the high voltage power supply (HVPS), motors, fixing unit, and so on, and the output terminal Vₒ of the second rectifier 106. The switching unit 107 includes a transistor 107b which can be turned on and off in response to a signal P_CONT output from the controller 108 for managing power, and a relay 107a having relay contacts for applying the output voltage of the second rectifier 106 to the function modules 110. The relay 107a is activated by a driving coil connected between the output terminal Vₒ of the second rectifier 106 and ground when the transistor 107b turns on. The output voltage of the second rectifier 106 is not applied to the function modules 110 when the switching unit 107 turns off, such that the function modules 110 can not consume power. The switching unit 107 turns off when the signal P_CONT from the controller 108 is applied to the base of the transistor 107b, such as when the image-forming apparatus is in the idle state or when the apparatus cover is open.

The controller 108 outputs the signal P_CONT to the switching unit 107 to turn off the relay 107a in response to a signal C_OPEN generated from a cover sensor (not shown) detecting that the apparatus cover is open, such as when the user opens the cover for toner replacement. The transistor 107b of the switching unit 107 turns on when the signal P_CONT is in a “high” logic state, and provides a path for current to be applied to the driving coil of the relay 107a. Thus, when the relay 107a turns on, the output voltage of the output terminal Vₒ of the second rectifier 106 is applied to the function modules 110 provided in the image-forming apparatus. However, when the signal P_CONT is in a “low” logic state, the transistor 107b turns off, and in turn, the relay 107a turns off, such that the power to the function modules 110 is cut off. Therefore, the image-forming apparatus consumes less power.

The switch 109 is provided on the exterior of the image-forming apparatus for easy access, preferably, on the operation panel (not shown). A user can then easily press the switch 109 to reduce the power consumption of the image-forming apparatus when desired.

Specifically, the switch 109 is installed between the output terminal Vₒ of the second rectifier 106 and the controller 108, and when turned on, the switch applies the output voltage of the second rectifier 106 to the controller 108. The controller 108 then outputs the signal P_CONT having a “low” logic state to the switching unit 107 in response to the output voltage of the second rectifier 106 applied by the switch 109. In this example, if the controller 108 is a single processor, the switch 109 can be connected between the output terminal Vo of the second rectifier 106 and the interrupt pin of the general processor. In this example, the control circuit is shown to be separately provided in the present embodiment, but in yet other embodiments of the present invention, the control circuit can be built into the image-processing unit or the engine control unit of the image-forming apparatus.

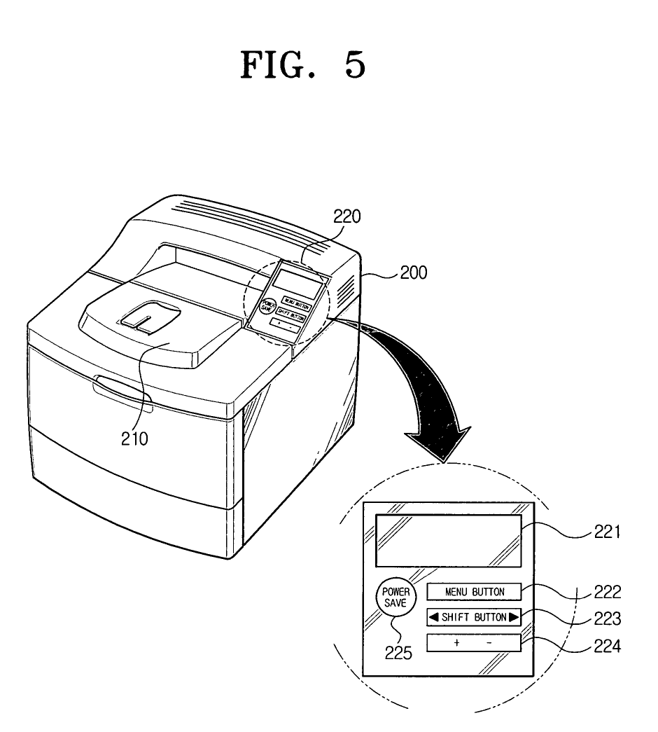

FIG. 5 is a perspective view for illustrating a position of the switch 109 of FIG. 4 when installed on the image-forming apparatus in accordance with an embodiment of the present invention.

FIG. 5 shows a laser printer 200 comprising an image-forming apparatus, wherein the laser printer 200 includes a cover 210 for replacing toner, and an operation panel 220 for enabling a user to control the laser printer 200. As shown in FIG. 5, the operation panel 220 has a display unit 221 for displaying the states of the laser printer, a menu button 222 for calling forth a menu for controlling the laser printer, a shift button 223 for shifting between options displayed on the display unit 221 by the menu button 222, a value-setting button 224 for increasing or decreasing the predetermined values set to the laser printer, and a POWER_SAVE switch 225. The switch 225 is substantially the same as the switch 109 shown in FIG. 4, and is provided at a convenient position for a user to press to reduce the power consumption of the laser printer 200. For reference in the printer 200 shown in FIG. 5, the user can open the cover 210 to replace toner, correct paper jams occurring during the printing job of the laser printer 200, clean the laser printer 200, or repair the laser printer 200. When doing so, the user can be protected from high voltage since the voltage to the high voltage power supply 50 of the laser printer 200 is cut off by a control signal C_OPEN generated from a cover sensor (not shown) detecting whether the cover 210 is open. Further, the switch 225 provided on the operation panel 220 can be a switch having a low withstand voltage and current rating when compared to a conventional switch coupled in a manner to directly switch the AC power on and off. Therefore, the present invention has an advantage in that the cost for the switch 225 provided on the laser printer 200 can be lowered, and further provides for a user to easily reduce the power consumption of the laser printer 200 at a desired time, as the switch 225 is conveniently disposed on the operation panel 220.

As noted above, embodiments of the present invention enable users to effectively manage power consumption by the use of the relay for the power supply that is controlled by a switch provided on the operation panel. This enables a user to manage power consumption whenever the user desires to do so, and can be applied to laser printers, digital photocopiers, facsimile machines, combination machines combining the above three devices, and so on, which consume a substantial amount of power. Further, a switch having a low withstand voltage and current rating can be used since there is no need for the switch to be directly connected to the AC power, which can result in a cost reduction effect for the image-forming apparatus.

The foregoing embodiments and advantages are merely exemplary, and are not to be construed as limiting the present invention. The present teachings can be readily applied to other types of apparatuses. Also, the descriptions of embodiments of the present invention are intended to be illustrative, and not to limit the scope of the claims, and many alternatives, modifications, and variations will be apparent to those skilled in the art.

1. A power supply for an image-forming apparatus having a power management function, comprising:
a power supply unit for rectifying and converting AC power into DC power and for applying the DC power to at least one or more function modules comprising the image-forming apparatus;
a switching unit provided between an output terminal of the power supply unit and an input terminal of each of the function modules;
a control unit for turning the switching unit either on or off when the image-forming apparatus sets a power management mode; and
a power-saving switch provided between an output terminal of the power supply unit and the control unit for applying an output voltage of the power supply unit to the control unit, wherein the output voltage is applied to the control unit as a signal for setting the power management mode.

2. The power supply as claimed in claim 1, further comprising:
an operation panel disposed at one side of the main body of the image-forming apparatus wherein the switching unit is provided, to enable a manipulation for setting the power management mode of the image-forming apparatus.

3. The power supply as claimed in claim 1, wherein the image-forming apparatus further comprises:
a cover for accessing the function modules; and
a sensor for detecting whether the cover is open, wherein the switching unit is turned off if the cover is detected to be open.

4. The power supply as claimed in claim 1, wherein the switching unit comprises:
a relay having a relay contact connected between the output terminal of the power supply unit and the function modules, and having a driving coil for activating the relay contacts wherein one end of the driving coil is connected to the output terminal of the power supply unit; and
a transistor having an emitter electrode connected to the other end of the driving coil, a collector electrode connected to ground, and a base electrode connected to the control unit to receive a signal for setting the power management mode.

5. A power supply for an image-forming apparatus, comprising:
a print engine unit for performing print tasks with respect to data to be printed;
an image-processing unit for converting the print data into data in an image data format;
an engine control unit for controlling the print engine unit to perform the print tasks with respect to the image data; and
a power supply unit for driving the print engine unit, image-processing unit, and engine control unit, wherein the power supply unit comprises a relay for turning on and off an output voltage thereof, and wherein the relay is turned off by the engine control unit when the image-forming apparatus enters a power management mode for reducing power consumption.

6. The power supply as claimed in claim 5, wherein the image-forming apparatus further comprises:
an operation panel disposed at one side of the image-forming apparatus to enable a user to manipulate the image-forming apparatus, and further comprising a switch for turning off the relay for selectively setting the power management mode.

7. The power supply as claimed in claim 5, wherein the image-forming apparatus further comprises:
an operation panel disposed at one side of the image-forming apparatus to enable a user to manipulate the image-forming apparatus, and further comprising a switch for turning on and off the output voltage of the power supply unit.

8. The power supply as claimed in claim 5, wherein the power management mode comprises a mode for reducing power applied to the print engine unit when print data is not supplied to the image-processing unit for a certain period of time.

9. The power supply as claimed in claim 5, wherein the power management mode is set by activating the relay upon opening of a cover shielding an interior of the image-forming apparatus.

10. A method for providing a power management function for an image-forming apparatus, comprising the steps of:
providing a DC power supply to at least one or more function modules comprising the image-forming apparatus;
controlling a switching unit to selectively switch the DC power supply to the function modules off and on in response to a power management mode setting; and
controlling a power-saving switch to provide a signal for setting the power management mode.

11. The method for providing a power management function as claimed in claim 10, further comprising the steps of:
controlling at least one sensor for detecting whether an apparatus cover is open, and providing a signal for setting the power management mode if an apparatus cover is detected to be open.

12. The method for providing a power management function as claimed in claim 11, wherein the step of providing a signal for setting the power management mode further comprises the steps of:
driving a transistor when the signal is received for setting the power management mode such that at least one relay is activated to selectively switch the DC power supply off and on in response to the signal.

13. The method for providing a power management function as claimed in claim 11, further comprising the step of:
switching the DC power supply to at least one of the function modules off if the apparatus cover is detected to be open.

14. The method for providing a power management function as claimed in claim 10, further comprising the step of:
switching the DC power supply to at least one of the function modules off if the power-saving switch is activated.
